(19) United States
(12) Patent Application Publication
(10) Pub. No.: US 2009/0302544 A1
(43) Pub. Date: Dec. 10, 2009

(54) Air Duct Sealing System

(76) Inventor: Charles A. Pugh, JR., Chico, CA (US)

Correspondence Address: BULLIVANT HOUSER BAILEY PC, 1415 L STREET, SUITE 1000, SACRAMENTO, CA, 95814, US

(21) Appl. No.: 12/134,086

(22) Filed: Jun. 5, 2008

(51) Int. Cl. F16J 15/02

(52) U.S. Cl. 277/312; 277/637

(57) ABSTRACT

This invention provides a seal for an air duct vent, the seal comprising: a) a substantially planar main body having a perimeter and an angled margin at the perimeter; b) a gasket along the perimeter for engaging a surface; and c) at least one fastener attached to the main body for engaging a vent cover.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files and records, but otherwise reserves all other copyright rights.

### BACKGROUND OF THE INVENTION

1. Field of the Invention

The invention relates to home air duct testing systems.

2. Description of Related Art

Homes with central heating and air-conditioning systems rely on ductwork to distribute warmed or cooled air throughout the house.

Heating and cooling systems have markedly improved in efficiency recently, in part from strict building and appliance codes, but also from the efficiency of new products that use less energy. In modern HVAC systems, the ductwork typically consists of insulated flexible tubes that snake across the attic floor or under the house. HVAC is an acronym that stands for “heating, ventilating, and air conditioning”. HVAC systems are also sometimes referred to as climate control.

Unfortunately, HVAC ducts are not visible, and therefore the ductwork can have substantial leaking without anyone noticing.

Air ducts can leak for a number of reasons, from faulty installation, such as failure to attach ductwork together or to properly connect it to the vent in the wall, or over time as joints and junctions where two pieces of duct come together separate.

Problems can also occur where the ducting is blocked or kinked.

In many jurisdictions it is now required that home heating systems be inspected for waste and inefficiency. The California Energy Commission, under Title 24, has set minimum standards of efficiency for HVAC systems that must comply during new construction or remodels. It is expected that many other states will follow California's model if they have not already. One of the tests used to determine air leaks, thus lost efficiency is a test consists of a calibrated fan, pressure tape to temporarily seal all the registers and grills, flexible duct to fasten the system to the central return or the air handler cabinet of the duct system; and a digital manometer to measure fan flow and duct pressure. Duct leakage is measured by precisely measuring the duct pressure. Duct leakage measurements are used to diagnose and demonstrate leakage problems, estimate efficiency losses from duct leakage, and certify the quality of duct system installation.

Unfortunately, duct tests are expensive, requiring a lot of man-hours, and expensive equipment to conduct the testing. The current method of sealing ventilation grills and registers involves considerable labor just to tape each grill closed, making the operation cumbersome and time consuming.

Further, the use of tape on the surfaces surrounding the ventilation grills often results in damage to the paint and drywall, often necessitating touch up or repair to the surface.

The problems with the current system prevents more frequent and common testing of existing HVAC systems by the owners, in spite of the fact that considerable savings can result to the building owner from correcting an inefficient an leaky duct system.

### SUMMARY OF THE INVENTION

This invention describes a device and method that reduces the amount of labor and time to adequately seal HVAC registers and grills to allow for the pressurization of the system.

More particularly, the invention provides a seal for an air duct vent, the seal comprising: a) a substantially planar main body having a perimeter and an angled margin at the perimeter; b) a gasket along the perimeter for engaging a surface; and c) at least one fastener attached to the main body for engaging a vent cover.

In one preferred embodiment, the main body is resilient. The main body has an open position and a sealing position, where in the sealing position the main body is under tension.

In a further preferred embodiment, in the sealing position the fastener is engaged with the vent cover.

In the sealing position the gasket is pressed against a surface surrounding the vent.

In a preferred embodiment, the main body is metal. In another preferred embodiment, the main body is produced of polymeric material.

In another preferred embodiment, the gasket is produced of rubber. In a different preferred embodiment, the gasket is produced of polymeric material.

In a preferred embodiment, the gasket comprises a separate structure attached to the perimeter. In a different preferred embodiment, the gasket is integral with the perimeter.

In a preferred embodiment, the fastener is a hook. In a still preferred embodiment, the fastener is sized to pass between adjacent louvers of the vent.

In a preferred embodiment, the fastener comprises a separate structure attached to the main body. In a separate preferred embodiment, the fastener is integral with the main body.

In a preferred embodiment, the plane of the main body and the plane formed by the perimeter are spaced. The space is preferably between about 1 inch and about 6 inches.

In a preferred embodiment, the margin is between about 1 inch and about 6 inches.

In a preferred embodiment, the seal further comprises a plurality of fasteners.

The invention also provides a method for sealing an air duct vent, the method comprising the steps of: a) placing a seal against a vent cover, the seal comprising a substantially planar main body having a perimeter and an angled margin at the perimeter, a gasket along the perimeter for engaging a surface, and a fastener attached to the main body for engaging a vent cover, where the main body is resilient; b) moving the main body from an open position to a sealing position by moving the fastener toward the surface; and c) engaging the fastener with the vent cover to secure the main body in the sealing position; where in the sealing position the gasket is pressed against a surface surrounding the vent.

These and other features and advantages of this invention are described in, or are apparent from, the following detailed description of various exemplary embodiments of the apparatus and methods according to this invention.

### BRIEF DESCRIPTION OF THE DRAWINGS

A more complete understanding of the present invention and the attendant features and advantages thereof may be had by reference to the following detailed description when considered in conjunction with the accompanying drawings wherein:

FIG. 1 is a perspective top view of the resilient cover invention.

FIG. 2 is an underside view that depicts the hook retain into the universal grill.

FIG. 3 depicts is a perspective view of only the cover part.

FIG. 4 depicts an underside view of only the cover part.

### DETAILED DESCRIPTION OF THE INVENTION

The resilient cover and methods of the present invention provide a duct testing system that reduces the amount of labor and time to adequately seal HVAC registers and grills to allow for the pressurization and testing of the system.

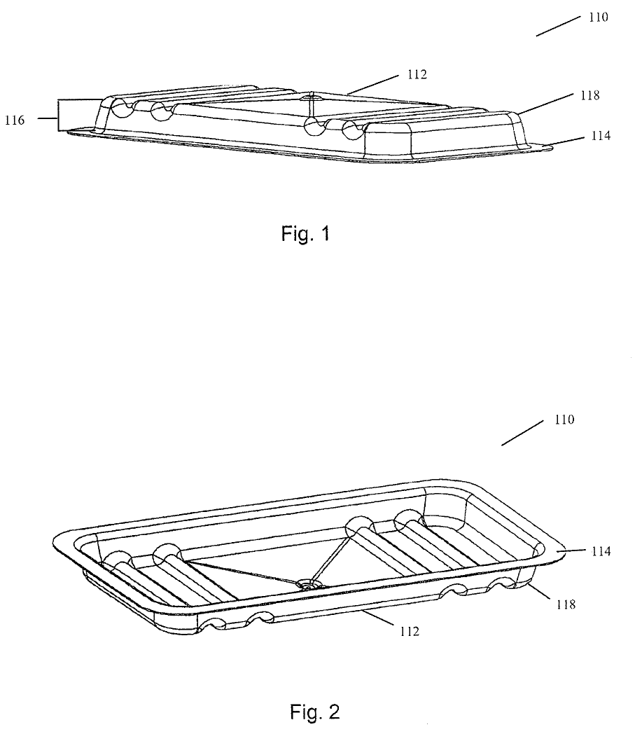

FIG. 1 is an isometric top view of the main body of the resilient cover 110, while FIG. 2 shows s similar perspective of the underside of the main body 110. The main body 110 has a substantially planar portion 112, a perimeter 114 and a margin 116 at the perimeter that is angled with respect to the planar portion. This margin 116 can be any distance that will create an adequate clearance between the planar portion 112 and the grill or register of the vent, generally between about 1 inch and about 6 inches.

The angle between the margin and planar portion is shown to be close to a right angle 118, but different angles are contemplated.

The resilient cover 110 is designed to be easily manufactured by thermoforming processes using polymeric materials, but could be manufactured a number of alternative methods, including being formed of a resilient metal, such as aluminum and the like.

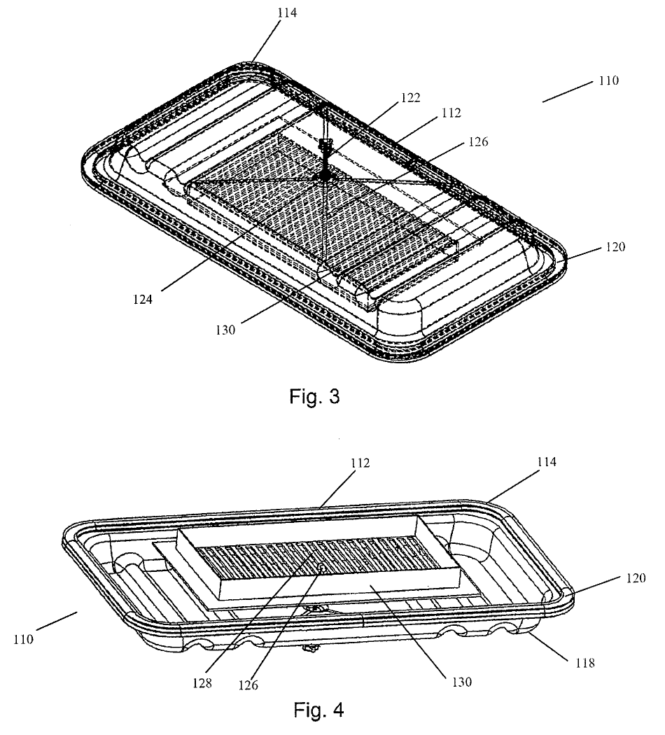

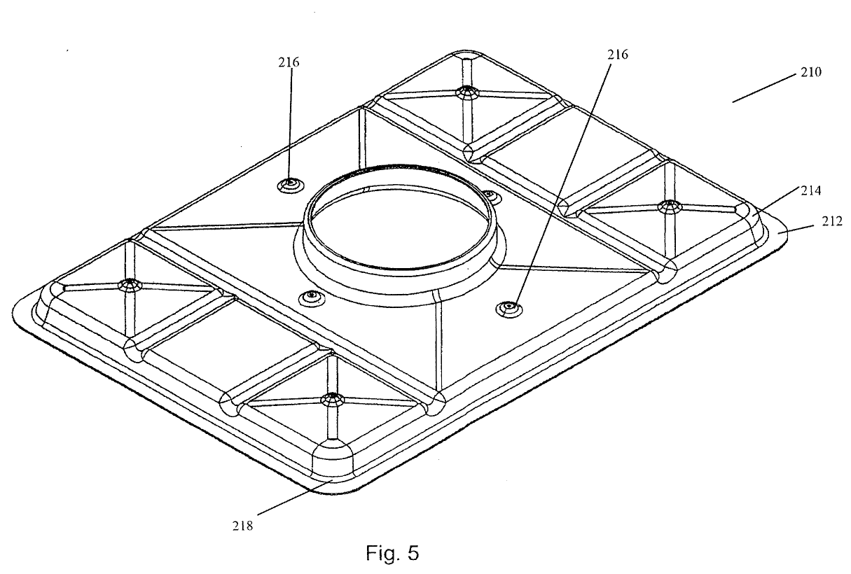

FIGS. 3 and 4 depict a clear resilient cover 110. The use of a clear plastic allows an installer to see the grill 130 that is being engaged through the main body 110.

A soft flexible gasket 120 is also depicted at the perimeter, to allow sealing on irregular or uneven surfaces.

FIGS. 3 and 4 also depict the fastener 122 for securing the resilient cover 110 to a vent grill 130. The fastener 122 is depicted as a hook assembly, wherein a proximal portion 124 is secured to the resilient cover 110 and the distal end has a hook 126 for engaging a cross piece of louver of the vent grill 130.

The hook assembly 122 allows for securing the resilient cover 110 to adjustable grill heights. In the figures, securement of the proximal end 124 to the main body 110 is provided by adjustable nuts and washers on a threaded fastener proximal end. Other systems could be easily adapted, including forming the fastener integrally with the main body 110.

Incorporated into the design is the spring force created by deformation of the main body 110, which provide the necessary force to seal the cover around the grill 130. This is done by the installer by pushing the assembly to the ceiling pushing the hook 126 into the grill 130 rotating the hook 126 and releasing the assembly 122. The unit 110 is now secure around the grill 130. The proper tension between an open position and a sealing position, is created by the size, thickness and choice of materials for the main body 110.

The resilient cover 110 also includes a gasket 120 along the perimeter 114 for engaging a surface. The gasket 120 can be rubber of any suitable polymeric material, and can be a separate structure attached to the perimeter 114, or is integral with the perimeter 114.

As seen in FIG. 5, the resilient cover 210 may have more than one fastener 216 attached to the main body 210 for engaging a larger grill or register of a vent cover.

In sealing an air duct vent using the resilient cover 210, the basic steps are: a) placing a seal against a vent cover, the seal comprising a substantially planar main body 210 having a perimeter 212 and an angled margin at the perimeter 214, a gasket 218 along the perimeter for engaging a surface, and a fastener 216 attached to the main body 210 for engaging a vent cover, where the main body 210 is resilient; b) moving the main body from an open position to a sealing position by moving the fastener 216 toward the surface; and c) engaging the fastener 216 with the vent cover to secure the main body 210 in the sealing position; where in the sealing position the gasket 218 is pressed against a surface surrounding the vent.

This allows the quick sealing of a HVAC grill.

The resilient cover 210 reduces labor cost for HVAC system tests, reduces long term material costs and waste for non reusable tape, reduces possible damage to painted and wallpapered surfaces, and ensures a more repeatable test by minimizing taping variations currently employed.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A seal for an air duct vent, said seal comprising:
a) a substantially planar main body having a perimeter and an angled margin at said perimeter;
b) a gasket along said perimeter for forming a seal against a surface; and
c) at least one fastener attached to said main body for engaging the vent cover.

2. The seal of claim 1 wherein said main body is resilient.

3. The seal of claim 2 wherein said main body has an open position and a sealing position, whereby in said sealing position the main body is under tension.

4. The seal of claim 3 wherein in said sealing position said fastener is engaged with said vent cover.

5. The seal of claim 3 wherein in said sealing position said gasket is pressed against the surface surrounding said vent.

6. The seal of claim 1 wherein said main body is metal.

7. The seal of claim 1 wherein said main body is produced of polymeric material.

8. The seal of claim 1 wherein said gasket is produced of rubber.

9. The seal of claim 1 wherein said gasket is produced of polymeric material.

10. The seal of claim 1 wherein said gasket comprises a separate structure attached to said perimeter.

11. The seal of claim 1 wherein said gasket is integral with said perimeter.

12. The seal of claim 1 wherein said fastener is a hook.

13. The seal of claim 1 wherein said fastener is sized to pass between adjacent louvers of said vent.

14. The seal of claim 1 wherein said fastener comprises a separate structure attached to said main body.

15. The seal of claim 1 wherein said fastener is integral with said main body.

16. The seal of claim 1 wherein said the plane of said main body and the plane formed by the perimeter are spaced.

17. The seal of claim 16 wherein said space is between about 1 inch and about 6 inches.

18. The seal of claim 1 wherein said margin is between about 1 inch and about 6 inches.

19. The seal of claim 1 comprising a plurality of fasteners.

20. A method for sealing an air duct vent, said method comprising the steps of:
a) placing a seal against a vent cover, said seal comprising a substantially planar main body having a perimeter and an angled margin at said perimeter, a gasket along said perimeter forming a seal against a surface, and a fastener attached to said main body for engaging a vent cover, wherein said main body is resilient;
b) moving the main body from an open position to a sealing position by moving said fastener toward said surface; and
c) engaging said fastener with said vent cover to secure said main body in the sealing position;
whereby in said sealing position said gasket is pressed against a surface surrounding said vent.
